(19) United States
(12) Patent Application Publication
(10) Pub. No.: US 2026/0070199 A1
(43) Pub. Date: Mar. 12, 2026

(54) TOOL FOR REPLACING BUSHING AND SEAL OF INLET BALL VALVE DISC PIVOT AND METHOD THEREOF

(71) Applicants: YUNNAN UNITED POWER DEVELOPMENT CO., LTD., Kunming (CN); HUANENG LANCANG RIVER HYDROPOWER INC., Kunming (CN)

(72) Inventors: Wenjun QIN, Kunming (CN); Dinghong GU, Kunming (CN); Ji WANG, Kunming (CN); Shihu WU, Kunming (CN); Honge GUO, Kunming (CN); Chengkai WANG, Kunming (CN); Yuchen DENG, Kunming (CN); Bo XU, Kunming (CN); Min WANG, Kunming (CN); Wei DING, Kunming (CN)

(73) Assignees: YUNNAN UNITED POWER DEVELOPMENT CO., LTD., Kunming (CN); HUANENG LANCANG RIVER HYDROPOWER INC., Kunming (CN)

(21) Appl. No.: 19/391,978

(22) Filed: Nov. 17, 2025

(30) Foreign Application Priority Data
Aug. 25, 2025 (CN) 202511190112.2

(51) Int. Cl. B25B 27/28

(52) U.S. Cl. CPC B25B 27/28

(57) ABSTRACT

A tool for replacing a bushing and seal of an inlet ball valve disc pivot and a method thereof, relating to the technical field of installation and maintenance of hydropower station equipment. The tool for replacing the bushing and seal of the inlet ball valve disc pivot comprises a support frame, a driving ring, a support shaft, a first support assembly and a second support assembly; the support frame includes a first ring, a second ring provided in parallel, and a plurality of connecting rods connected between the first ring and the second ring; the first ring is used for connecting to the ball valve body; the driving ring is provided between the first ring and the second ring in an adjustable position; the driving ring is used for detachable connection with the bushing; the support shaft is used for coaxial connection with the pivot.

### TECHNICAL FIELD

The present invention relates to the technical field of installation and maintenance of hydropower station equipment, and particularly, to a tool for replacing a bushing and seal of an inlet ball valve disc pivot and a method thereof.

### BACKGROUND ART

Ball valves are one of the common water valves in hydropower stations, suitable for high-head hydropower stations, and the inlet ball valves are one of the most critical equipment of hydropower station. The main components of a ball valve include a valve body, a disc, a valve shaft, bearings, a sealing device, an operating device, auxiliary components, etc. The ball valve pivot is installed inside the valve body, which mainly bears the axial horizontal thrust and vibration when the disc is opened and closed, and plays a crucial role in the normal operation of the ball valve. After long-term operation, the copper bushing of the ball valve pivot may be worn, and at the same time, the seal may undergo plastic deformation or damage due to gradual aging, particle wear, distortion, etc., which results in seal failure. Once water leakage occurs at the ball valve pivot, it may cause serious safety accidents, such as equipment damage and flooding of the powerhouse.

In the related art, the valve shaft is supported by devices such as a chain hoist with a support plate. During the replacement process, a relatively large operating space is required, and the selection of support points is relatively restrictive due to environmental constraints. Meanwhile, the operation of disassembling the bushing and seal is cumbersome, time-consuming, and labor-intensive.

### SUMMARY OF THE PRESENT INVENTION

The present invention aims to solve one of the technical problems in the related art at least to a certain extent.

To this end, an embodiment of the present invention provides a tool for replacing a bushing and seal of an inlet ball valve disc pivot. This tool can realize the rapid replacement of the bushing and seal, reduce the space required for maintenance, improve the efficiency of equipment maintenance, and is easy to operate, safe, and reliable.

An embodiment of the present invention also provides a method for replacing a bushing and seal of an inlet ball valve disc pivot.

The tool for replacing the bushing and seal of the inlet ball valve disc pivot according to an embodiment of the present invention comprises:
a support frame comprising a first ring, a second ring arranged in parallel to each other, and a plurality of connecting rods connected between the first ring and the second ring, wherein the first ring is used for connecting to the ball valve body and is coaxially arranged with the pivot;
a support shaft used for coaxial connection with the pivot;
a driving ring arranged between the first ring and the second ring in an adjustable position and sleeved on the support shaft, wherein the driving ring is used for detachable connection with the bushing;
a first support assembly arranged on a side of the connecting rod close to the second ring and has an adjustable length for supporting the support shaft;
a second support assembly arranged on a side of the connecting rod close to the first ring and has an adjustable length for supporting the support shaft.

The tool for replacing the bushing and seal of an inlet ball valve disc pivot according to the embodiment of the present invention can realize the rapid replacement of the bushing and seal, improve the efficiency of equipment maintenance, and is easy to operate, safe, and reliable.

In some embodiments, the tool for replacing the bushing and seal of the inlet ball valve disc pivot further comprises a connecting ring arranged between the first ring and the second ring in an adjustable position, the connecting ring is detachably connected to the driving ring, and the inner diameter of the connecting ring is larger than the outer diameter of the bushing and the outer diameter of the seal.

In some embodiments, the tool for replacing the bushing and seal of the inlet ball valve disc pivot further comprises at least two adjusting rods extending along an axial direction of the first ring and being respectively rotatably matched with the first ring and the second ring, and the connecting ring is in threaded connection with the adjusting rods.

In some embodiments, a driving gear is arranged on the adjusting rod close to the second ring, a driving gear ring is rotatably arranged on the second ring, and the driving gear ring is in meshing transmission with the driving gear.

In some embodiments, a plurality of first support assemblies are provided corresponding to the connecting rods, each of the first support assemblies comprises a first hydraulic push rod and a first pressing plate arranged at a movable end of the first hydraulic rod, the first hydraulic push rod is used for telescoping along a radial direction of the first ring to push the first pressing plate to move, and the plurality of first pressing plates are used for supporting a circumferential side of the support shaft.

In some embodiments, the first hydraulic push rod is rotatably provided on the connecting rod and has a first position and a second position; in the first position, the first hydraulic push rod extends along the radial direction of the first ring, and the first pressing plate is located on a side of the first hydraulic push rod close to the support shaft; in the second position, the first hydraulic push rod extends along the radial direction of the first ring, and the first pressing plate is located on a side of the first hydraulic push rod far away from the support shaft.

In some embodiments, a plurality of second support assemblies are provided corresponding to the connecting rods, each of the second support assemblies comprises a second hydraulic push rod and a second pressing plate provided at a movable end of the second hydraulic rod, the second hydraulic push rod is used for telescoping along the radial direction of the first ring to push the second pressing plate to move, and the plurality of second pressing plates are used for supporting a circumferential side of the support shaft.

In some embodiments, a shaft shoulder is provided on the support shaft, and a diameter of the shaft shoulder is not larger than a diameter of the bushing.

In some embodiments, a connecting flange is arranged at an end of the support shaft, and the connecting flange is detachably connected to the pivot through bolts.

The method for replacing a bushing and seal of an inlet ball valve disc pivot according to the embodiment of the present invention comprises the tool for replacing the bushing and seal of the inlet ball valve disc pivot according to any one of the above embodiments, wherein the method comprises the following steps:
S1: remove the ball valve actuator, the rotating arm and the auxiliary equipment of the inlet ball valve;
S2: connect the support shaft coaxially corresponding to the pivot, and install the support frame on the ball valve body corresponding to the pivot;
S3: adjust the position of the driving ring, connect the driving ring with the bushing, adjust the first support assembly to support and fix the support shaft, and move the driving ring in the direction away from the valve body to remove the bushing and the seal;
S4: adjust the second support assembly to support and fix the support shaft, adjust the first support assembly to release the supporting and fixing of the support shaft, and remove the bushing and seal to be replaced from the support shaft;
S5: sleeve the bushing and seal to be installed on the support shaft, adjust the first support assembly to support and fix the support shaft, and adjust the second support assembly to release the supporting and fixing of the support shaft;
S6: move the driving ring to push the bushing and seal to be installed to move until the bushing and seal are installed in place.

In some embodiments, the replacement tool further comprises a connecting ring arranged between the first ring and the second ring in an adjustable position, the connecting ring is detachably connected to the driving ring, and in step S4, when disassembling the bushing and the seal ring, the driving ring is removed from the connecting ring so as to remove the bushing, the seal and the driving ring from the support shaft.

### BRIEF DESCRIPTION OF THE DRAWINGS

FIG. 1 is a structural schematic diagram of the tool for replacing the bushing and seal of an inlet ball valve disc pivot according to an embodiment of the present invention;

FIG. 2 is a schematic diagram of the tool for replacing the bushing and seal of an inlet ball valve disc pivot according to an embodiment of the present invention in use;

FIG. 3 is a structural schematic diagram of the support frame in the tool for replacing the bushing and seal of an inlet ball valve disc pivot according to an embodiment of the present invention;

FIG. 4 is a structural schematic diagram of the support shaft in the tool for replacing the bushing and seal of an inlet ball valve disc pivot according to an embodiment of the present invention;

FIG. 5 is a structural schematic diagram of the driving ring and the connecting ring in the tool for replacing the bushing and seal of an inlet ball valve disc pivot according to an embodiment of the present invention; and

FIG. 6 is a structural schematic diagram of the first support assembly in the tool for replacing the bushing and seal of an inlet ball valve disc pivot according to an embodiment of the present invention.

### REFERENCE NUMERALS

support frame 1; first ring 11; second ring 12; connecting rod 13; first connecting section 131; first baffle ring 132; first limit nut 133; adjusting rod 14; driving gear 15; driving gear ring 16;
support shaft 2; connecting flange 21; shaft body 22; shaft shoulder 23;
driving ring 3; limit block 31;
first support assembly 4; first hydraulic push rod 41; first pressing plate 42; first connecting cylinder 43;
second support assembly 5;
connecting ring 6; limit groove 61;
valve body 7;
pivot 8;
bushing 9;
seal 10.

### DETAILED DESCRIPTION OF THE EMBODIMENTS

The embodiments of the present invention will be described in detail below. Examples of the embodiments are shown in the accompanying drawings. The embodiments described below with reference to the accompanying drawings are exemplary and are intended to explain the present invention, and should not be construed as limiting the present invention.

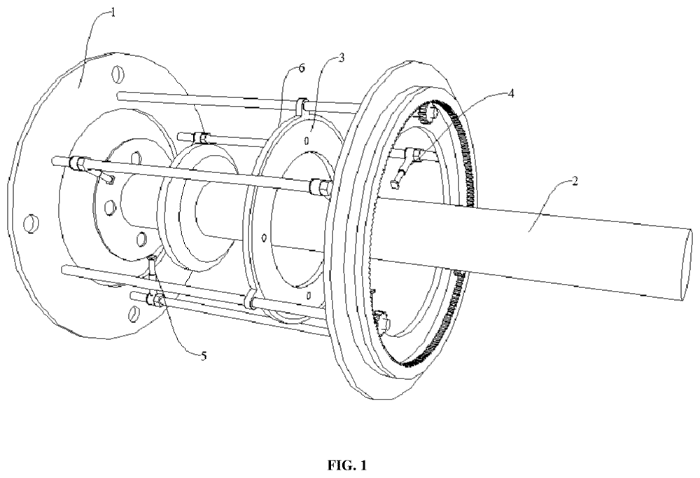

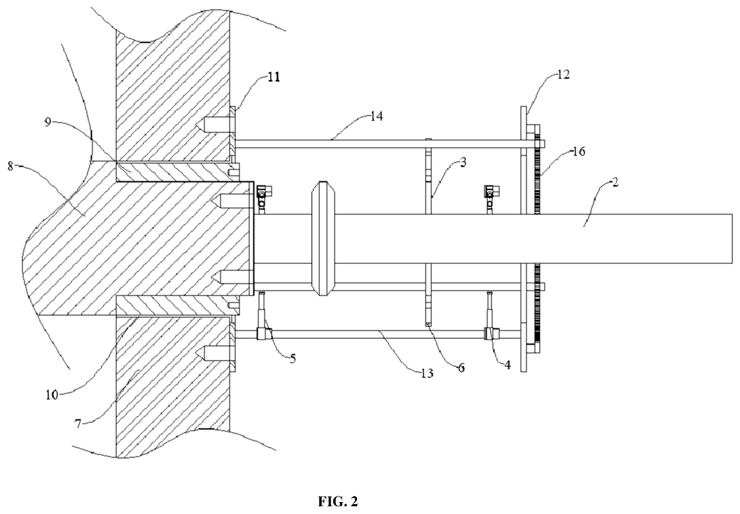

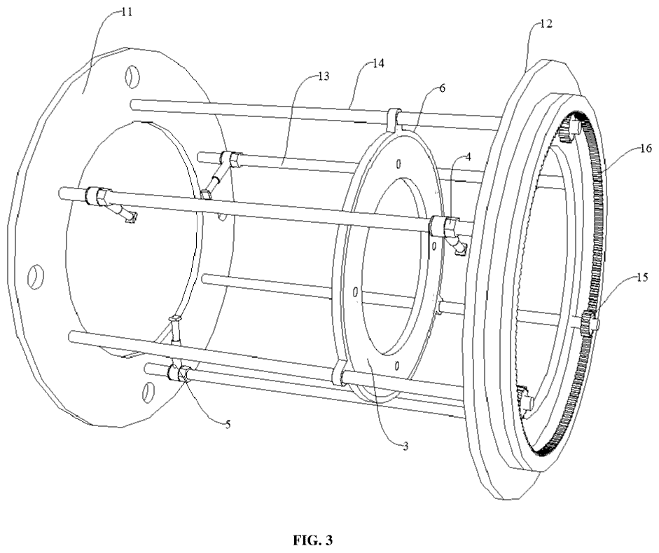

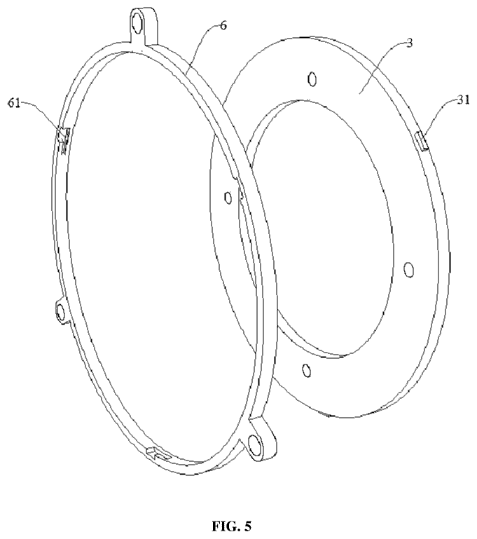

As shown in FIGS. 1 to 6, the tool for replacing the bushing 9 and seal 10 of an inlet ball valve disc pivot 8 according to an embodiment of the present invention comprises a support frame 1, a support shaft 2, a driving ring 3, a first support assembly 4, and a second support assembly 5.

The support frame 1 comprises a first ring 11, a second ring 12, and a plurality of connecting rods 13, wherein the first ring 11 and the second ring 12 are arranged in parallel to each other, the plurality of connecting rods 13 are arranged between the first ring 11 and the second ring 12, and two ends of each connecting rod 13 are respectively fixedly connected to the first ring 11 and the second ring 12, respectively, and the plurality of connecting rods 13 are arranged at intervals along the circumferential direction of the first ring 11. A plurality of first through holes are arranged at intervals along the circumferential direction of the first ring 11, and when installing the support frame 1, the first through holes are aligned with the threaded blind holes on the ball valve body, and bolts are inserted to realize the detachable connection between the first ring 11 and the valve body 7, and at the same time, the first ring 11 is arranged coaxially with the pivot 8.

The support shaft 2 comprises a connecting flange 21 and a shaft body 22, wherein the connecting flange 21 is detachably connected to the pivot 8 through bolts, and the pivot 8 is supported by supporting the shaft body 22, further, when disassembling and assembling the bushing 9 and the seal 10, the stability and parallelism of the pivot 8 relative to the valve body 7 are ensured, and the rapid disassembly and assembly of the bushing 9 and the seal 10 are realized.

The driving ring 3 is arranged between the first ring 11 and the second ring 12 in an adjustable position and sleeved on the support shaft 2, wherein the driving ring 3 is used for detachable connection with the bushing 9, specifically, the driving ring 3 is provided with second through holes, when disassembling the bushing 9, the second through holes are aligned with the threaded blind holes on the bushing 9, and the detachable connection between the driving ring 3 and the bushing 9 is realized through bolts.

The first support assembly 4 is arranged on a side of the connecting rod 13 close to the second ring 12 and is has an adjustable length, the first support assembly 4 is used for supporting the support shaft 2, the second support assembly 5 is provided on a side of the connecting rod 13 close to the first ring 11 and is has an adjustable length, and the second support assembly 5 is used for supporting the support shaft 2.

When using the tool for replacing the bushing 9 and seal 10 of an inlet ball valve disc pivot 8 according to the embodiment of the present invention, remove the ball valve actuator, rotating arm, and auxiliary equipment of the inlet ball valve to prepare for disassembling the bushing 9 and seal 10 of the pivot 8, when disassembling the bushing 9 and seal 10, connect the support shaft 2 to the pivot 8 via bolts and the connecting flange 21, connect the first ring 11 to the valve body 7 with bolts, move the driving ring 3, connect the driving ring 3 to the bushing 9 through bolts, adjust the first support assembly 4 to support and fix the support shaft 2, move the driving ring 3 to drive the bushing 9 and seal 10 to move until the bushing 9 and seal 10 are disassembled from the pivot 8, when the bushing 9 and seal 10 move between the first support assembly 4 and the second support assembly 5, adjust the second support assembly 5 to support and fix the support shaft 2, and adjust the first support assembly 4 to release its jacking and securing on the support shaft 2, then remove the bushing 9, seal 10, and driving ring 3 from the support shaft 2.

When installing the bushing 9 and seal 10, sleeve the bushing 9 and seal 10 to be installed on the support shaft 2, install the driving ring 3 on the support shaft 2, move the driving ring 3 together with the bushing 9 and seal 10 to be installed between the first support assembly 4 and the second support assembly 5, adjust the first support assembly 4 to support and fix the support shaft 2, and adjust the second support assembly 5 to release its jacking and securing on the support shaft 2, and move the driving ring 3 to push the bushing 9 and seal 10 to move, thereby completing the installation of the bushing 9 and seal 10.

The tool for replacing the bushing 9 and seal 10 of an inlet ball valve disc pivot 8 according to the embodiment of the present invention is provided with the support frame 1 connected to the valve body 7, and support points are selected on the support frame 1 to support the pivot 8, which is easy to operate and greatly reduces the requirement for the ball valve maintenance space, it can realize the rapid replacement of the bushing 9 and seal 10, improve the efficiency of equipment maintenance, and is easy to operate, safe and reliable.

In some embodiments, as shown in FIGS. 1, 2, 3 and 5, the tool further comprises a connecting ring 6 arranged between the first ring 11 and the second ring 12 in an adjustable position, the connecting ring 6 is detachably connected to the driving ring 3, and the inner diameter of the connecting ring 6 is larger than the outer diameter of the bushing 9 and the outer diameter of the seal 10.

Specifically, the outer circumferential side of the driving ring 3 is provided with a plurality of limit blocks 31, the inner circumferential side of the connecting ring 6 is provided with a plurality of limit grooves 61 corresponding to the limit blocks 31, the cross section of the limit groove 61 is L-shaped and includes a first groove section and a second groove section, the second groove section is an arc-shaped groove, when connecting the driving ring 3 and the connecting ring 6, align the limit blocks 31 of the driving ring 3 with the first groove section, so that the plurality of limit blocks 31 fit into the first groove section respectively, then move the limit blocks 31 to the position where the first groove section is connected to the second groove section, and rotate the driving ring 3 relative to the connecting ring 6, so that the limit blocks 31 assemble into the second groove section and realize the axial stop between the driving ring 3 and the connecting ring 6, and the connection between the driving 3 and the connecting ring 6 can be released by simply rotating the driving ring 3 relative to the connecting ring 6;

Alternatively, the driving ring 3 and the connecting ring 6 are provided with connecting lugs, respectively, and bolts are arranged on the connecting lugs to realize detachable connection.

The connecting ring 6 is provided to drive the driving ring 3 to move, facilitating the disassembly of the driving ring 3, the bushing 9 and the seal 10 from the support shaft 2 when disassembling the bushing 9 and the seal 10, which is convenient for operation, at the same time, the detachable connection between the driving ring 3 and the connecting ring 6 is realized through the limit blocks 31 and the limit grooves 61, which simplifies assembly and disassembly and improves the replacement efficiency of the bushing 9 and the seal 10.

In some embodiments, as shown in FIGS. 1, 2 and 3, the tool further comprises at least two adjusting rods 14 extending along an axial direction of the first ring 11 and being respectively rotatably matched with the first ring 11 and the second ring 12, and the connecting ring 6 is in threaded connection with the adjusting rods 14.

At least two adjusting rods 14 are arranged to connect to the connecting ring 6, which can ensure the connection reliability of the connecting ring 6 and limit the moving direction of the connecting ring 6, and facilitating the disassembly of the bushing 9 and the seal 10 along the circumferential direction of the pivot 8, the adjusting rods 14 are in threaded fit with the connecting ring 6, and the adjustment of the position of the connecting ring 6 can be enabled by rotating the plurality of adjusting rods 14 simultaneously, which is convenient for operation, moreover, the plurality of adjusting rods 14 can prevent the connecting ring 6 from jamming due to uneven local stress during movement, and can realize the rapid disassembly of the bushing 9 and the seal 10.

Optionally, a plurality of adjusting lugs are provided on the circumferential direction of the connecting ring 6 corresponding to the adjusting rod 14, and the connecting ring 6 is threadedly engaged with the adjusting rod 14 through the adjusting lugs.

In some embodiments, as shown in FIGS. 1, 2 and 3, a driving gear 15 is arranged on the adjusting rod 14 close to the second ring 12, a driving gear ring 16 is rotatably arranged on the second ring 12, and the driving gear ring 16 is in meshing transmission with the driving gear 15.

By arranging a driving gear 15 on the adjusting rod 14 and arranging a driving gear ring 16 on the second ring 12 through a rotating ring or a bearing, the simultaneous driving of a plurality of meshing gears can be realized by rotating the driving gear ring 16, ensuring the consistent rotation speed of the plurality of adjusting rods 14, and thereby ensuring the stable driving of the connecting ring 6, which is safe, reliable and easy to operate.

Optionally, the driving gear ring 16 is provided with an operating handle, and a person can rotate the operating handle to realize the rotation of the driving gear ring 16.

Optionally, the second ring 12 is provided with a driving motor, an output end of the driving motor is provided with a transmission gear, and the transmission gear is in meshing transmission with the driving gear ring 16, the driving gear ring 16 is driven to rotate by the driving motor, so as to reduce the labor intensity of personnel and improve the operation efficiency.

In some embodiments, a side of the driving ring 3 away from the pivot 8 may also be provided with a traction part, when the bushing 9 and the seal 10 are disassembled, the bushing 9 is driven to move through the traction part, in this case, the disassembly of the bushing 9 and the seal 10 can also be realized, but it is relatively labor-intensive.

In some embodiments, as shown in FIGS. 1, 2 and 3, a plurality of first support assemblies 4 are provided corresponding to the connecting rods 13, each of the first support assemblies 4 comprises a first hydraulic push rod 41 and a first pressing plate 42 arranged at a movable end of the first hydraulic rod, the first hydraulic push rod 41 is used for telescoping along a radial direction of the first ring 11 to push the first pressing plate 42 to move, and the plurality of first pressing plates 42 are used for supporting the circumferential side of the support shaft 2.

Specifically, the plurality of connecting rods 13 are arranged at equal intervals along the circumferential direction of the first ring 11, the first support assemblies 4 are arranged in one-to-one correspondence with the connecting rods 13, when the support shaft 2 is jacked and secured, the plurality of first hydraulic push rods 41 are extended to make the plurality of first pressing plates 42 press against the circumferential side of the support shaft 2, so as to realize the jacking and securing of the support shaft 2, ensure the unchanged position and parallelism of the support shaft 2 and the pivot 8 relative to the valve body 7, and facilitate the disassembly and assembly of the bushing 9 and the seal 10.

In some embodiments, the first hydraulic push rod 41 is rotatably arranged on the connecting rod 13 and has a first position and a second position, in the first position, the first hydraulic push rod 41 extends along the radial direction of the first ring 11, the first pressing plate 42 is located on the side of the first hydraulic push rod 41 close to the support shaft 2, in the second position, the first hydraulic push rod 41 extends along the radial direction of the first ring 11, and the first pressing plate 42 is located on the side of the first hydraulic push rod 41 far away from the support shaft 2.

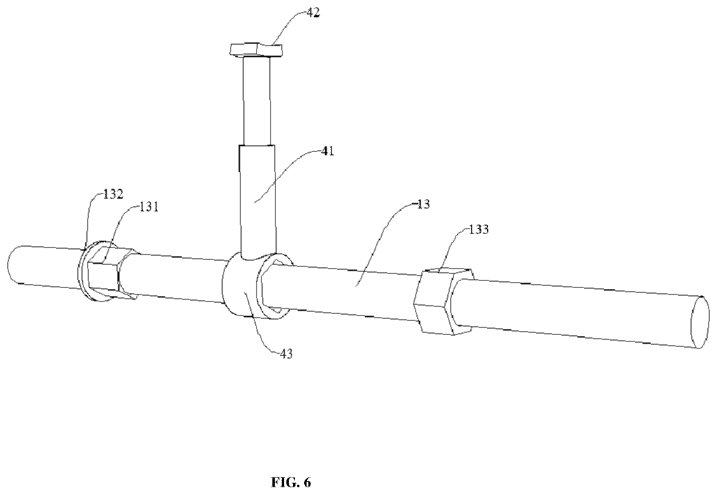

Specifically, as shown in FIG. 6, the connecting rod 13 is provided with a first connecting section 131 corresponding to the first support assembly 4, the cross section of the first connecting section 131 is a regular quadrilateral or a regular hexagon, one end of the first connecting section 131 is provided with a first baffle ring 132, the other end of the first connecting section 131 is threadedly connected to a first limit nut 133 on the connecting rod 13, the fixed end of the first hydraulic push rod 41 is provided with a first connecting cylinder 43, the first connecting cylinder 43 is coaxially provided with a first through hole, the cross section of the first through hole is the same as the shape and size of the cross section of the first connecting section 131, and the first connecting cylinder 43 is used for rotationally fixed assembly on the first connecting section 131;

When the first hydraulic push rod 41 is required to support and fix the support shaft 2, tighten the first limit nut 133 to release the axial limit of the first connecting cylinder 43, move the first connecting cylinder 43 and the first hydraulic push rod 41 along the axial direction of the connecting rod 13, when releasing the restriction of the first connecting section 131 on the first connecting cylinder 43, rotate the first connecting cylinder 43 relative to the connecting rod 13, so that the first hydraulic push rod 41 is located at the first position, that is, the first hydraulic push rod 41 extends along the radial direction of the first ring 11, the first pressing plate 42 is located on the side of the first hydraulic push rod 41 close to the support shaft 2, maintain the orientation of the first hydraulic push rod 41 and sleeve it on the first connecting section 131, tighten the first limit nut 133 to fix the axial position of the first connecting cylinder 43, and realize the jacking and securing of the support shaft 2 by extending the plurality of first hydraulic push rods 41;

When the first hydraulic push rod 41 is required to release the supporting and fixing of the support shaft 2, retract the plurality of first hydraulic push rods to release their jacking and securing of the support shaft 2, tighten the first limit nut 133 to release the axial limit of the first connecting cylinder 43, move the first connecting cylinder 43 and the first hydraulic push rod 41 along the axial direction of the connecting rod 13, when releasing the restriction of the first connecting section 131 on the first connecting cylinder 43, rotate the first connecting cylinder 43 relative to the connecting rod 13, so that the first hydraulic push rod 41 is located at the second position, that is, the first hydraulic push rod 41 extends along the radial direction of the first ring 11, the first pressing plate 42 is located on the side of the first hydraulic push rod 41 far away from the support shaft 2, maintain the orientation of the first hydraulic push rod 41 and sleeve it on the first connecting section 131, tighten the first limit nut 133 to fix the axial position of the first connecting cylinder 43, and realize the jacking and securing of the support shaft 2 by extending the plurality of first hydraulic push rods 41; at this time, the first hydraulic push rod 41 is located on the outer side of the connecting rod 13, which provides space for the installation and disassembly of the connecting ring 6, the driving ring 3, the bushing 9 and the seal 10, avoids interference with the connecting ring 6 and the driving ring 3, and under the condition that the sizes of the connecting ring 6 and the driving ring 3 are certain, the size of the support frame 1 can be effectively reduced, thereby reducing the overall volume of the tool and facilitating installation and operation by personnel.

In some embodiments, a plurality of second support assemblies 5 are provided corresponding to the connecting rods 13, each of the second support assemblies 5 has the same structure as the first support assembly 4 and comprises a second hydraulic push rod and a second pressing plate arranged at a movable end of the second hydraulic rod, the second hydraulic push rod is used for telescoping along the radial direction of the first ring 11 to push the second pressing plate to move, and the plurality of second pressing plates are used for supporting the circumferential side of the support shaft 2.

Specifically, the second support assemblies 5 are arranged in one-to-one correspondence with the connecting rods 13, when the support shaft 2 is jacking and securing, the plurality of second hydraulic push rods are extended to make the plurality of second pressing plates press against the circumferential side of the support shaft 2, so as to realize the jacking and securing of the support shaft 2, ensure the unchanged position and parallelism of the support shaft 2 and the pivot 8 relative to the valve body 7, and facilitate the disassembly and assembly of the bushing 9 and the seal 10.

In some embodiments, the second hydraulic push rod is rotatably arranged on the connecting rod 13 and has a third position and a fourth position; in the third position, the second hydraulic push rod extends along the radial direction of the first ring 11, and the second pressing plate is located on a side of the second hydraulic push rod close to the support shaft 2; in the fourth position, the second hydraulic push rod extends along the radial direction of the first ring 11, and the second pressing plate is located on a side of the second hydraulic push rod far away from the support shaft 2.

Specifically, the connecting rod 13 is provided with a second connecting section corresponding to the second support assembly 5, the cross section of the second connecting section is a regular quadrilateral or a regular hexagon, one end of the second connecting section is provided with a second baffle ring, the other end of the second connecting section is threadedly connected to a second limit nut on the connecting rod 13, the fixed end of the second hydraulic push rod is provided with a second connecting cylinder, the second connecting cylinder is coaxially provided with a second through hole, the cross section of the second through hole is the same as the shape and size of the cross sectional of the second connecting section, and the second connecting cylinder is used for rotationally fixed assembly on the second connecting section;

When the second hydraulic push rod is required to support and fix the support shaft 2, tighten the second limit nut to release the axial limit of the second connecting cylinder, move the second connecting cylinder and the second hydraulic push rod along the axial direction of the connecting rod 13, when releasing the restriction of the second connecting section on the second connecting cylinder, rotate the second connecting cylinder relative to the connecting rod 13, so that the second hydraulic push rod is located at the third position, that is, the second hydraulic push rod extends along the radial direction of the first ring 11, the second pressing plate is located on the side of the second hydraulic push rod close to the support shaft 2, maintain the orientation of the second hydraulic push rod and sleeve it on the second connecting section, tighten the second limit nut to fix the axial position of the second connecting cylinder, and realize the jacking and securing of the support shaft 2 by extending the plurality of second hydraulic push rods;

When it is necessary to release the supporting and fixing of the support shaft 2 by the second hydraulic push rod, retract the plurality of second hydraulic push rods to release their jacking and securing of the support shaft 2, tighten the second limit nut to release the axial limit of the second connecting cylinder, move the second connecting cylinder and the second hydraulic push rod along the axial direction of the connecting rod 13, when releasing the restriction of the second connecting section on the second connecting cylinder, rotate the second connecting cylinder relative to the connecting rod 13, so that the second hydraulic push rod is located at the fourth position, that is, the second hydraulic push rod extends along the radial direction of the first ring 11, the second pressing plate is located on the side of the second hydraulic push rod far away from the support shaft 2, maintain the orientation of the second hydraulic push rod and sleeve it on the second connecting section, tighten the second limit nut to fix the axial position of the second connecting cylinder; at this time, the second hydraulic push rod is located on the outer side of the connecting rod 13, which provides space for the installation and disassembly of the connecting ring 6, the driving ring 3, the bushing 9 and the seal 10, avoids interference with the connecting ring 6 and the driving ring 3, and under the condition that the sizes of the connecting ring 6 and the driving ring 3 are certain, the size of the support frame 1 can be effectively reduced, thereby reducing the overall volume of the tool and facilitating installation and operation by personnel.

Optionally, there are two connecting rods 13, and two first support assemblies 4 and two second support assemblies 5 are respectively provided.

Optionally, there are three connecting rods 13, and three first support assemblies 4 and three second support assemblies 5 are respectively provided.

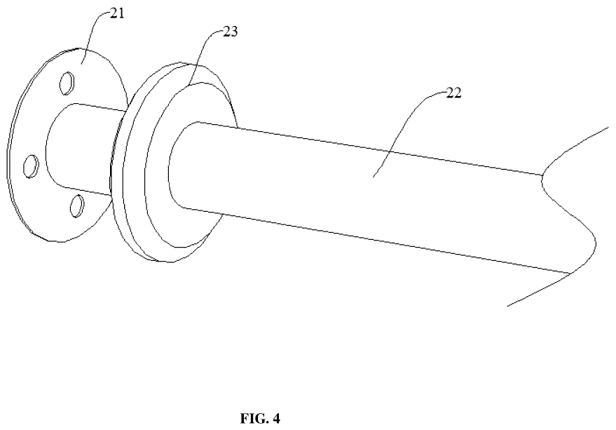

In some embodiments, as shown in FIG. 4, the support shaft 2 is provided with a shaft shoulder 23, and the diameter of the shaft shoulder 23 is not larger than the diameter of the bushing 9, by providing the shaft shoulder 23, the bushing 9 and the seal 10 can be positioned when they are installed, which facilitates the rapid installation of the bushing 9.

Optionally, both sides of the axial direction of the shaft shoulder 23 are provided with chamfers to facilitate the guiding of the bushing 9 during installation and disassembly.

The following describes the method for replacing the bushing 9 and seal 10 of an inlet ball valve disc pivot 8 according to an embodiment of the present invention.

The method for replacing the bushing 9 and seal 10 of an inlet ball valve disc pivot 8 according to an embodiment of the present invention comprises the tool for replacing the bushing 9 and seal 10 of the inlet ball valve disc pivot 8 according to any one of the above embodiments, wherein the method comprises the following steps:
S1: remove the ball valve actuator, the rotating arm and the auxiliary equipment of the inlet ball valve;
S2: connect the support shaft 2 coaxially corresponding to the pivot 8, and install the support frame 1 on the ball valve body 7 corresponding to the pivot 8;
S3: adjust the position of the driving ring 3, connect the driving ring 3 with the bushing 9, adjust the first support assembly 4 to support and fix the support shaft 2, and move the driving ring 3 in the direction away from the valve body 7 to remove the bushing 9 and the seal 10;
S4: adjust the second support assembly 5 to support and fix the support shaft 2, adjust the first support assembly 4 to release the supporting and fixing of the support shaft 2, and remove the bushing 9 and seal 10 to be replaced from the support shaft 2;
S5: sleeve the bushing 9 and seal 10 to be installed on the support shaft 2, adjust the first support assembly 4 to support and fix the support shaft 2, and adjust the second support assembly 5 to release the supporting and fixing of the support shaft 2;
S6: move the driving ring 3 to push the bushing 9 and seal 10 to be installed to move until the bushing 9 and seal 10 are installed in place.

The method for replacing the bushing 9 and seal 10 of an inlet ball valve disc pivot 8 according to the embodiment of the present invention provides support points by connecting the support frame 1 to the valve body 7, which greatly reduces the requirement for the operating space when replacing the bushing 9 and seal 10 of the pivot 8, moreover, the rapid disassembly and assembly of the bushing 9 and seal 10 are realized through the driving ring 3, which is easy to operate and greatly improves the replacement efficiency.

In some embodiments, the replacement tool further comprises a connecting ring 6 provided between the first ring 11 and the second ring 12 in an adjustable position, the connecting ring is detachably connected to the driving ring 3, and in step S4, when disassembling the bushing 9 and the seal ring, the driving ring 3 is removed from the connecting ring 6 so as to remove the bushing 9, the seal 10 and the driving ring 3 from the support shaft 2, the connecting ring 6 is used to drive the driving ring 3 to move, so that the driving ring 3, the bushing 9 and the seal 10 can be easily disassembled from the support shaft 2 when the bushing 9 and the seal 10 are disassembled, which is convenient for operation, at the same time, the detachable connection between the driving ring 3 and the connecting ring 6 is realized through the limit blocks 31 and the limit grooves 61, which is convenient for assembly and disassembly and can improve the replacement efficiency of the bushing 9 and the seal 10.

In the description of the present invention, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like indicate orientations or positional relationships based on the orientations or positional relationships shown in the accompanying drawings, which are only for the convenience of describing the present invention and simplifying the description, rather than indicating or implying that the device or element referred to must have a specific orientation, be constructed and operated in a specific orientation, and thus cannot be understood as limiting the present invention.

In addition, the terms “first” and “second” are only used for descriptive purposes, and cannot be understood as indicating or implying relative importance or implicitly indicating the number of indicated technical features, thus, the features defined with “first” and “second” may explicitly or implicitly include at least one such feature, in the description of the present invention, “a plurality of” means at least two, such as two, three, etc., unless otherwise explicitly and specifically defined.

In the present invention, unless otherwise clearly specified and limited, the terms “installed”, “connected with”, “connected to”, “fixed” and other terms should be understood in a broad sense, for example, they can be fixedly connected, detachably connected or integrated; they can be mechanically connected, electrically connected or can communicate with each other; they can be directly connected or indirectly connected through an intermediate medium, and can be the internal communication of two elements or the interaction relationship between two elements, unless otherwise clearly defined, for those of ordinary skill in the art, the specific meanings of the above terms in the present invention can be understood according to specific situations.

In the present invention, unless otherwise clearly specified and limited, the first feature “on” or “under” the second feature can be that the first and second features are in direct contact, or the first and second features are in indirect contact through an intermediate medium, moreover, the first feature being “above”, “over” and “on” the second feature can be that the first feature is directly above or obliquely above the second feature, or it only means that the horizontal height of the first feature is higher than that of the second feature, the first feature being “below”, “under” and “beneath” the second feature can be that the first feature is directly below or obliquely below the second feature, or it only means that the horizontal height of the first feature is lower than that of the second feature.

In the description of this specification, the description with reference to the terms “one embodiment”, “some embodiments”, “examples”, “specific examples”, or “some examples” and the like means that the specific features, structures, materials or characteristics described in connection with the embodiment or example are included in at least one embodiment or example of the present invention, in this specification, the schematic expressions of the above terms are not necessarily directed to the same embodiment or example, moreover, the described specific features, structures, materials or characteristics can be combined in an appropriate manner in any one or more embodiments or examples, in addition, those skilled in the art can combine and combine different embodiments or examples and features of different embodiments or examples described in this specification without conflicting with each other.

Although the embodiments of the present invention have been shown and described above, it can be understood that the above embodiments are exemplary and cannot be understood as limiting the present invention, those of ordinary skill in the art can make changes, modifications, substitutions and variations to the above embodiments within the scope of the present invention.

What is claimed is:

1. A tool for replacing a bushing and seal of an inlet ball valve disc pivot comprising:
a support frame comprising a first ring, a second ring arranged in parallel to each other, and a plurality of connecting rods connected between the first ring and the second ring, wherein the first ring is used for connecting to the ball valve body and is coaxially arranged with the pivot;
a support shaft used for coaxial connection with the pivot;
a driving ring arranged between the first ring and the second ring in an adjustable position and sleeved on the support shaft, wherein the driving ring is used for detachable connection with the bushing;
a first support assembly arranged on a side of the connecting rod close to the second ring and has an adjustable length for supporting the support shaft; and
a second support assembly arranged on a side of the connecting rod close to the first ring and has an adjustable length for supporting the support shaft.

2. The tool for replacing the bushing and seal of the inlet ball valve disc pivot according to claim 1, wherein the tool further comprises a connecting ring arranged between the first ring and the second ring in an adjustable position, the connecting ring is detachably connected to the driving ring, and an inner diameter of the connecting ring is larger than an outer diameter of the bushing and an outer diameter of the seal.

3. The tool for replacing the bushing and seal of the inlet ball valve disc pivot according to claim 2, wherein the tool further comprises at least two adjusting rods extending along an axial direction of the first ring and being rotatably matched with the first ring and the second ring, respectively, and the connecting ring is in threaded connection with the adjusting rods.

4. The tool for replacing the bushing and seal of the inlet ball valve disc pivot according to claim 3, wherein a driving gear is arranged on the adjusting rod close to the second ring, a driving gear ring is rotatably arranged on the second ring, and the driving gear ring is in meshing transmission with the driving gear.

5. The tool for replacing the bushing and seal of the inlet ball valve disc pivot according to claim 1, wherein a plurality of first support assemblies are provided corresponding to the connecting rods, each of the first support assemblies comprises a first hydraulic push rod and a first pressing plate arranged at a movable end of the first hydraulic rod, the first hydraulic push rod is used for telescoping along a radial direction of the first ring to push the first pressing plate to move, and the plurality of first pressing plates are used for supporting a circumferential side of the support shaft.

6. The tool for replacing the bushing and seal of the inlet ball valve disc pivot according to claim 5, wherein the first hydraulic push rod is rotatably arranged on the connecting rod and has a first position and a second position; in the first position, the first hydraulic push rod extends along the radial direction of the first ring, and the first pressing plate is located on a side of the first hydraulic push rod close to the support shaft; in the second position, the first hydraulic push rod extends along the radial direction of the first ring, and the first pressing plate is located on a side of the first hydraulic push rod far away from the support shaft.

7. The tool for replacing the bushing and seal of the inlet ball valve disc pivot according to claim 5, wherein a plurality of second support assemblies are provided corresponding to the connecting rods, each of the second support assemblies comprises a second hydraulic push rod and a second pressing plate arranged at a movable end of the second hydraulic rod, the second hydraulic push rod is used for telescoping along the radial direction of the first ring to push the second pressing plate to move, and the plurality of second pressing plates are used for supporting a circumferential side of the support shaft.

8. The tool for replacing the bushing and seal of the inlet ball valve disc pivot according to claim 1, wherein a shaft shoulder is arranged on the support shaft, and a diameter of the shaft shoulder is not larger than a diameter of the bushing;
and/or, a connecting flange is arranged at an end of the support shaft, and the connecting flange is detachably connected to the pivot through bolts.

9. A method for replacing a bushing and seal of an inlet ball valve disc pivot, based on the tool for replacing the bushing and seal of the inlet ball valve disc pivot according to claim 1, wherein the method comprises the following steps:
S1: remove a ball valve actuator, a rotating arm and an auxiliary equipment of the inlet ball valve;
S2: connect the support shaft coaxially corresponding to the pivot, and install the support frame on the ball valve body corresponding to the pivot;
S3: adjust a position of the driving ring, connect the driving ring with the bushing, adjust the first support assembly to support and fix the support shaft, and move the driving ring in the direction away from the valve body to remove the bushing and the seal;
S4: adjust the second support assembly to support and fix the support shaft, adjust the first support assembly to release the supporting and fixing of the support shaft, and remove the bushing and seal to be replaced from the support shaft;
S5: sleeve the bushing and seal to be installed on the support shaft, adjust the first support assembly to support and fix the support shaft, and adjust the second support assembly to release the supporting and fixing of the support shaft;
S6: move the driving ring to push the bushing and seal to be installed to move until the bushing and seal are installed in place.

10. The method for replacing the bushing and seal of the inlet ball valve disc pivot according to claim 9, wherein the replacement tool further comprises a connecting ring provided between the first ring and the second ring in an adjustable position, the connecting ring is detachably connected to the driving ring, and in step S4, when disassembling the bushing and the seal ring, the driving ring is removed from the connecting ring to remove the bushing, the seal and the driving ring from the support shaft.
